(19) United States
(12) Patent Application Publication
(10) Pub. No.: US 2024/0051345 A1
(43) Pub. Date: Feb. 15, 2024

(54) Tire Tread for a Heavy Vehicle with Improved Robustness

(71) Applicant: COMPAGNIE GENERALE DES ETABLISSEMENTS MICHELIN, Clermont-Ferrand (FR)

(72) Inventor: Olivier SPINNLER, Clermont-Ferrand Cedex 9 (FR)

(21) Appl. No.: 18/267,824

(22) PCT Filed: Dec. 3, 2021
(86) PCT No.: PCT/FR2021/052195

§ 371 Date: Jun. 16, 2023

(30) Foreign Application Priority Data
Dec. 17, 2020 (FR) FR2013441

(51) Int. Cl. B60C 11/03; B60C 11/12

(52) U.S. Cl. CPC B60C 11/0309; B60C 11/1236; B60C 2200/06; B60C 2011/0365; B60C 2011/0367; B60C 2011/0346

(57) ABSTRACT

A tire tread (1), for a heavy-duty construction plant vehicle, having an improved compromise between resistance to mechanical attack caused by stony ground and grip on muddy ground. The tread (1) having five rows (41, 42, 43) separated in pairs by a longitudinal cut (51, 52) and distributed, along the transverse direction (YY′), in a median row (43), two intermediate rows (42), and two lateral rows (41), the blocks (31, 32, 33) in one and the same row (41, 42, 43) being separated in pairs by a transverse cut (61, 62, 63), each transverse cut in a lateral row (41) is a transverse groove, each transverse cut (62) in an intermediate row (42) with a first transverse groove portion (621) and a second transverse sipe portion (622), and each transverse cut (63) in the median row (43) is a transverse sipe which is offset along the longitudinal direction (XX′).

The present invention relates to a tire tread for a heavy-duty vehicle intended to carry heavy loads and to run on uneven, stony and/or muddy ground such as, for example, a construction plant vehicle of the dumper type intended for use in mines or quarries.

A tread comprises at least one rubber-based material and is intended to constitute the peripheral part of a tire and to be worn away when its tread surface comes into contact with the ground.

A tread can be defined in geometric terms by three dimensions: a smaller dimension or thickness, along a direction perpendicular to the tread surface; an intermediate dimension or width, along a transverse direction; and a larger dimension or length, along a longitudinal direction. When the tread is incorporated in the tire, the transverse direction is also referred to as axial direction, since it is parallel to the axis of rotation of the tire, and the longitudinal direction is also referred to as circumferential direction, since it is tangential to the circumference of the tire in the direction of running of the tire.

To ensure a satisfactory performance in terms of longitudinal grip, under engine torque and braking torque, and transverse grip, it is necessary to form, in the tread, a combination of cuts separating raised elements, referred to as tread pattern.

The cuts can be of two types: grooves and sipes. Grooves are wide cuts that are essentially for storing and discharging water or mud that is present on the ground. A cut is referred to as wide when it has a width such that the facing walls of material delimiting it do not come into contact with one another when the tread enters the contact patch, the tire being subjected to recommended inflation and load conditions as are defined notably, for example, by the standard ISO 4250 and the standard of the “Tire and Rim Association” or TRA. Sipes are narrow cuts of which the intersections with the tread surface, or edge corners, contribute to grip on wet ground by virtue of an edge-corner effect in the contact patch which makes it possible to break the film of water present on the ground. A cut is referred to as narrow when it has a width such that the facing walls of material that delimit it come into contact with one another at least partially when the tread enters the contact patch, under the tire load and pressure conditions specified by the TRA as seen above.

A cut is often characterized by a mean surface that is equidistant from the walls delimiting the cut and intersecting the tread surface. The intersection of this mean surface and the tread surface is referred to as mean line of the cut. The mean line of a cut is not necessarily rectilinear and may, by way of examples, have a wavy shape or a zigzag shape. A cut is referred to as longitudinal in a broad sense when, at any point, its mean line has a tangent forming an angle with the longitudinal direction of the tread of between 0° and 45°. A cut is referred to as transverse in a broad sense when, at any point, its mean line has a tangent forming an angle with the transverse direction of the tread of between 0° and 45°.

In the case of a tire tread for a heavy-duty construction plant vehicle, the raised elements are generally blocks. A block is a volume of material delimited by a contact face, which is contained in the tread surface, by a bottom surface, and by lateral faces connecting the contact face to the bottom surface. These blocks may be arranged so as to form longitudinal rows of blocks, these rows being separated in pairs by longitudinal cuts of the groove or sipe type, also referred to as longitudinal voids. Furthermore, within one and the same longitudinal row of blocks, the blocks are most often separated in pairs by transverse cuts of the groove or sipe type.

The tread, incorporated in the tire, is most often characterized in geometric terms by a width L, along the transverse direction, and a thickness H, along a direction perpendicular to the tread surface. The width L is defined as the transverse width of that surface of the tread of the new tire that makes contact with smooth ground, such as tarmacked ground, when the tire is subjected to nominal pressure and load conditions recommended, for example, by the TRA standard. The thickness H is conventionally defined as the maximum radial depth measured in the cuts, corresponding to the maximum radial height of a block, when the tire is new. In the case of a tire for a construction plant vehicle of the dumper type, and by way of example, the width L is at least equal to 600 mm and the thickness H is at least equal to 60 mm, or even 70 mm.

The conventional running conditions of a tire for a construction plant vehicle are particularly harsh. By way of example, such a vehicle is intended to run on tracks that are most often sloping, either uphill, which requires good grip of the tires under traction, or downhill, which requires good grip of the tires under braking. In addition, these tracks are also often winding, this requiring good transverse grip of the tires. Lastly, the tracks on which the vehicles run are generally made up of materials extracted in situ, for example compacted crushed rocks which are regularly damped down in order to ensure the integrity of the wearing layer of the track as the vehicles pass along it and are often covered with mud and water: this requires both good resistance of the tread to attack, so as to ensure a satisfactory service life, and a good capacity both for this mixture of mud and water to penetrate and be discharged from the tread, so as to ensure satisfactory grip on muddy ground.

The specific use of a dumper, as described above, entails particular management of the tires fitted thereto. In the new state, a tire is usually fitted to the front axle, or steering axle, of the vehicle. At this front position, the load applied to the tire is generally estimated to be between 80% and 100% of its nominal load-bearing capacity, depending on whether the vehicle is running in an unladen or laden state, as defined, for example, by the standard ISO 4250 and the standard of the “Tire and Rim Association” or TRA. When the tire reaches around one third of its wear, meaning that the initial height in the new state of its tread has been reduced by one third, the tire is removed from the front axle and is fitted to a rear axle, or driven axle, of the vehicle. At this rear position, the load applied to the tire is generally estimated to be between 25% and 100% of its nominal load-bearing capacity, depending on whether the vehicle is running in an unladen or laden state. Lastly, the tire is permanently removed from the driven axle when its tread reaches a residual height corresponding to a completely worn state in accordance with the prevailing practice.

A tread comprising blocks and aiming to ensure good longitudinal grip under traction and under braking, satisfactory transverse grip, mud discharge capacity and satisfactory resistance to mechanical attack caused by the materials covering the tracks has already been described, for example in the document WO 2014170283.

The inventors have set themselves the aim, for a tread of a tire for a heavy-duty vehicle, in particular a heavy-duty construction plant vehicle, that comprises blocks, of further improving the compromise between resistance to mechanical attacks caused by stony ground and grip, in particular traction on muddy ground.

This aim has been achieved by a tread of a tire for a heavy-duty vehicle that is intended to come into contact with the ground via a tread surface, comprising blocks which are arranged in rows along a longitudinal direction and are delimited by cuts,
the tread having a width, measured along a transverse direction between two lateral edges of the tread surface, and a height, which is equal to the maximum depth of a cut measured perpendicularly to the tread surface,
it being possible for the cuts to be at least partially either a groove having a depth at least equal to 50% of the height of the tread and a width at least equal to 20% of the said depth, or a sipe having a depth at least equal to 50% of the height of the tread and a width strictly less than 20% of the said depth,
the tread comprising five rows which are separated in pairs by a longitudinal cut and are distributed, along the transverse direction, in a median row, centred on a median plane perpendicular to the tread surface at its middle, two intermediate rows, which are on either side of the median row and are symmetrical in relation to the median plane, and two lateral rows, which are transversely outermost and symmetrical in relation to the median plane,
the blocks in one and the same row being separated in pairs at least partially by a transverse cut,
each transverse cut in a lateral row being a transverse groove extending from a lateral edge of the tread surface to an outer longitudinal cut,
each transverse cut in an intermediate row comprising a first transverse groove portion, which continues a transverse groove in the neighbouring lateral row and extends from an outer longitudinal cut to a transversely inner end of a transverse groove portion, the latter being continued by a second transverse sipe portion extending to an inner longitudinal cut,
and in that each transverse cut in the median row being a transverse sipe which extends from a first inner longitudinal cut to a second inner longitudinal cut and is offset, along the longitudinal direction, in relation to every second transverse sipe portion in the neighbouring intermediate row.

The tread to which the invention relates therefore comprises five rows of blocks distributed in a median row of blocks, which is centred on the median plane of the tread, two lateral rows, which are symmetrical in relation to the median plane and are transversely on the outside, that is to say positioned at the tread edge, and two rows of intermediate blocks, each intermediate row being transversely positioned between the median row and a lateral row.

The presence of transverse grooves, each having a depth at least equal to 50% of the height of the tread and a width at least equal to 20% of the said depth, in each lateral row of blocks, the transverse grooves continuing in a transversely outer part of the intermediate row of blocks that is closest, ensures the creation of continuous channels between this transversely outer part of the intermediate row and the lateral row, thus enabling lateral discharge of water or mud that is present on the ground and thereby promoting the grip of the tire. These channels also contribute to cooling that part of the tire crown that is radially on the inside of these channels, and therefore to the endurance of the crown of the tire.

The presence of transverse sipes, each having a depth at least equal to 50% of the height of the tread and a width at most equal to 20% of the said depth, in the median row of blocks and in a transversely inner part of the intermediate row that is closest, ensures the closure of the median row and the transversely inner part of the intermediate rows, making it possible to protect the crown of the tire against attack caused by stones present on the ground. The central part of the tire, corresponding to a median row and to transversely inner parts of the intermediate rows, is specifically a region which exhibits strong pressures in the contact patch and is particularly sensitive to attack caused by stones.

In addition, each transverse sipe of the median row is offset, along the longitudinal direction, in relation to every second transverse sipe portion in the neighbouring intermediate row. This offset between the respective sipes in the median row and the neighbouring intermediate row in particular avoids the insertion of a stone in a manner straddling the median row and an intermediate row, thereby contributing to combating mechanical attacks on the tread.

Advantageously, each outer longitudinal cut has a mean line positioned, in relation to the median plane of the tread and along the transverse direction, at a mean distance at least equal to 20% of the width of the tread. The mean line of the cut is the plot, on the tread surface, of the mean surface of the cut that is equidistant from the walls of blocks delimiting it. Since the mean line of the cut is not necessarily strictly longitudinal, its mean distance in relation to the median plane is the mean of the distances of all of its points from the median plane. The above feature defines the minimum mean distance of each outer longitudinal cut from the median plane, and therefore correspondingly the maximum width of a lateral row. The resulting technical effect is to ensure an acceptable level of heat in the tire crown lateral portion that is radially on the inside of a tread edge and generally subjected to high temperatures.

Also advantageously, each outer longitudinal cut has a mean line positioned, in relation to the median plane of the tread and along the transverse direction, at a mean distance at most equal to 35% of the width of the tread. This feature defines the maximum mean distance of each outer longitudinal cut from the median plane, and therefore correspondingly the minimum width of a lateral row. The resulting technical effect is to ensure a level of stiffness of each lateral row that is acceptable as regards the wear of the tread when the tire is subjected to transverse cornering stresses.

Advantageously, each transversely inner end of a transverse groove portion in an intermediate row is positioned, in relation to the median plane of the tread and along the transverse direction, at a distance at least equal to 10% of the width of the tread. This feature implicitly defines a maximum engagement of the intermediate transverse groove portion in the intermediate row. If the intermediate transverse groove portion is excessively engaged, that is to say if its transversely inner end is too close to the median plane, it then extends into the region which exhibits strong pressures in the contact patch and is particularly sensitive to attacks caused by stones. This then makes the intermediate row more sensitive to attacks caused by stones.

Also advantageously, each transversely inner end of a transverse groove portion in an intermediate row is positioned, in relation to the median plane of the tread and along the transverse direction, at a distance at most equal to 25% of the width of the tread. This feature implicitly defines a minimum engagement of the intermediate transverse groove portion in the intermediate row. If the intermediate transverse groove portion is engaged to a sufficient extent, that is to say if its transversely inner end is close enough to the median plane, it then extends into the contact patch when the tire is subjected to a small load, typically under a load equal to 20% of its nominal load, when it is mounted in a twinned configuration on the rear axle of an unladen vehicle. In these conditions, the presence of a transverse groove in the contact patch ensures lateral discharge of water or mud that is present on the ground, thereby promoting the grip of the tire.

Advantageously, each inner longitudinal cut has a mean line positioned, in relation to the median plane of the tread and along the transverse direction, at a mean distance at least equal to 5% of the width of the tread. The mean line of the cut is the plot, on the tread surface, of the mean surface of the cut that is equidistant from the walls of blocks delimiting it. Since the mean line of the cut is not necessarily strictly longitudinal, its mean distance in relation to the median plane is the mean of the distances of all of its points from the median plane. This feature defines the minimum mean distance of each inner longitudinal cut from the median plane, and therefore correspondingly the minimum width of a median row. A median row which is not wide enough would then be made up of blocks that are narrow, and therefore less stiff and more sensitive to chunking.

Also advantageously, each inner longitudinal cut has a mean line positioned, in relation to the median plane of the tread and along the transverse direction, at a mean distance at most equal to 20% of the width of the tread. This feature defines the maximum mean distance of each inner longitudinal cut from the median plane, and therefore correspondingly the maximum width of a median row. A median row which is too wide would then be made up of blocks that are wide and therefore unfavourable to the thermal behaviour of the crown of the tire.

Preferably, each longitudinal cut separating two adjacent rows is a longitudinal sipe. These longitudinal sipes ensure closure, and therefore protection of the tread with regard to attacks caused by stones present on the ground. In addition, these longitudinal sipes limit the transverse movements of the rows of blocks via a shoulder effect between the rows when the tire is subjected to transverse stresses, such as when cornering. This transverse stiffening of the tread consequently limits the wear of the rows of blocks under cornering.

Also preferably, each inner longitudinal cut has a zigzag shape. The zigzag shape of the inner longitudinal cut improves the shoulder effect between the median row and an intermediate row when the tire is subjected to transverse stresses, this being of advantage in slowing down wear. In addition, the zigzag shape is a succession of segments which, in pairs, form angles greater than 90°, avoiding point effects and thus making the portions of material that delimit the sipe less sensitive to chunking.

Advantageously, with each block in a lateral row, delimited by two consecutive transverse grooves, having a block height along a direction perpendicular to the tread surface and a block length along the longitudinal direction, the block height is at most equal to 80% of the block length. Above 80%, the lateral row block becomes insufficiently stiff and therefore more sensitive to wear, in particular under cornering stresses.

Advantageously, with each block in a lateral row having a block length along the longitudinal direction, and each transverse groove, delimited by two blocks, having a transverse groove width along the longitudinal direction, the transverse groove width is at least equal to 18% of the sum of the transverse groove width and the block length. This feature defines a minimum void ratio of a lateral row of blocks, below which the discharge of water or mud via the lateral part of the tread becomes insufficient, this adversely affecting the grip of the tire.

Also advantageously, with each block in a lateral row having a block length along the longitudinal direction, and each transverse groove, delimited by two blocks, having a transverse groove width along the longitudinal direction, the transverse groove width is at most equal to 35% of the sum of the transverse groove width and the block length. This feature defines a maximum void ratio of a lateral row of blocks, above which the stiffness of the blocks in the lateral row becomes insufficient to ensure good resistance of the tire to wear.

Advantageously, at least one ventilation cavity, opening into the tread surface and having a depth at least equal to 70% of the height, is positioned, along the longitudinal direction, between at least two consecutive transverse grooves in one and the same lateral row. A ventilation cavity is a recess that is formed in the tread, along a substantially radial direction, and has a surface that opens onto the tread surface with a closed contour: it is therefore not a cut as seen above. Such a ventilation cavity is sometimes referred to as ventilation well. The presence of ventilation cavities in the lateral row blocks enables ventilation of the edge of the tread and therefore cooling of that radially inner crown portion that is a hot point of the tire, thereby limiting the degradation of the crown of the tire and improving its endurance.

According to a particular embodiment, the ventilation cavity comprises a radially outer first portion of which the inner wall is inclined at a first angle in relation to a direction perpendicular to the tread surface and which is continued radially towards the inside by a radially inner second portion of which the inner wall is inclined at a second angle, which is strictly less than the first angle, in relation to a direction perpendicular to the tread surface. An inner ventilation wall with a double slope limits the collection and retention of stones in the cavity, these stones being liable to generate cracks that are detrimental to the endurance of the crown of the tire.

Also advantageously, with the tread comprising two outer lateral faces, each intersecting the tread surface at a lateral edge of the tread surface, all transverse grooves in a lateral row opening into a lateral face of the tread along an open section, at least one ventilation cavity, opening into a lateral face of the tread but not into the tread surface when the tire is new, is positioned, along the longitudinal direction, between at least two surfaces into which consecutive transverse grooves in one and the same lateral row open. In the present case, a ventilation cavity is a recess that is formed in a lateral face of the tread, along a substantially transverse direction, and has a surface that opens out on the said tread face with a closed contour. The presence of ventilation cavities that open into a lateral face of the tread enables ventilation of the lateral face of the tread and therefore cooling of the ends of the crown reinforcement layers extending transversely on the inside of the said lateral face of the tread, thereby limiting the degradation of the crown of the tire and improving its endurance. Such a ventilation cavity does not open into the tread surface when the tire is new, in order to avoid initiating manifestations of irregular wear at the tread edge.

The invention also relates to a tire for a heavy-duty vehicle, preferably a heavy-duty construction plant vehicle, comprising a tread according to any one of the embodiments described above.

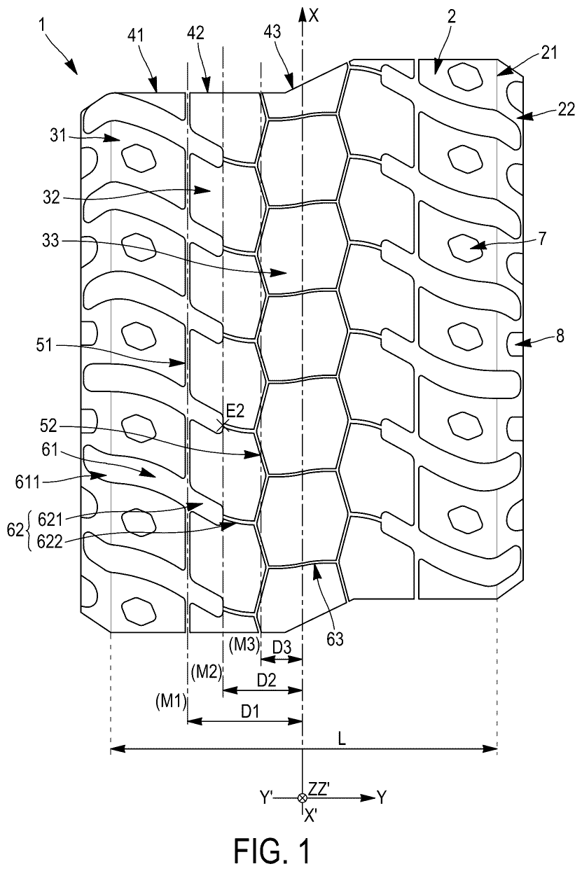

The features of the invention, for the tire size 59/80 R 63, are illustrated by FIGS. 1 to 7, which are not drawn to scale:

FIG. 1: Top view of a portion of a tread according to the invention,

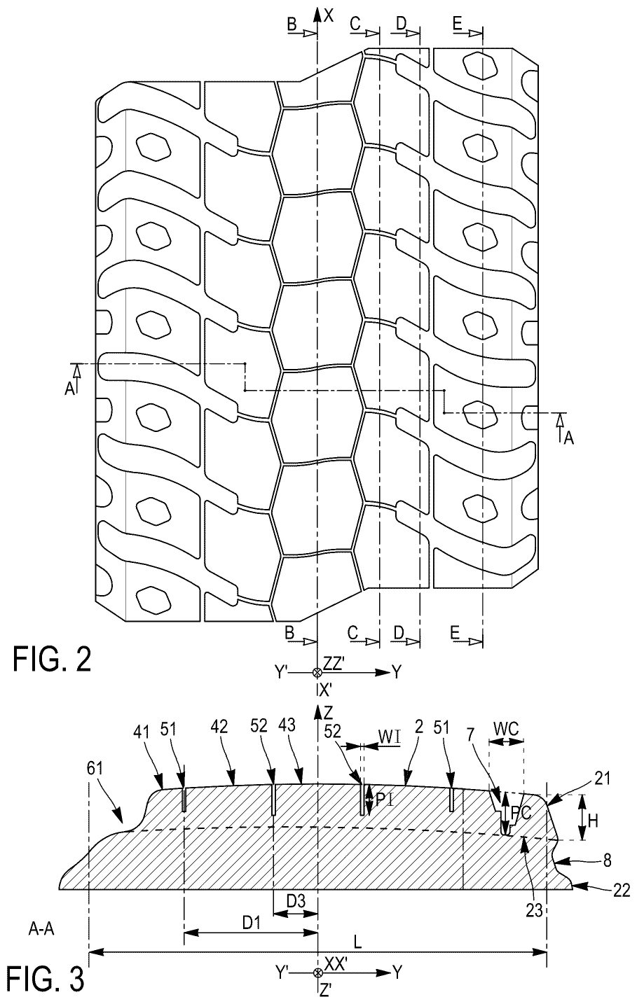

FIG. 2: Top view of a portion of a tread according to the invention, indicating the section planes of FIGS. 3 to 7,

FIG. 3: Meridian section of the tread according to the invention, along a broken section line A-A,

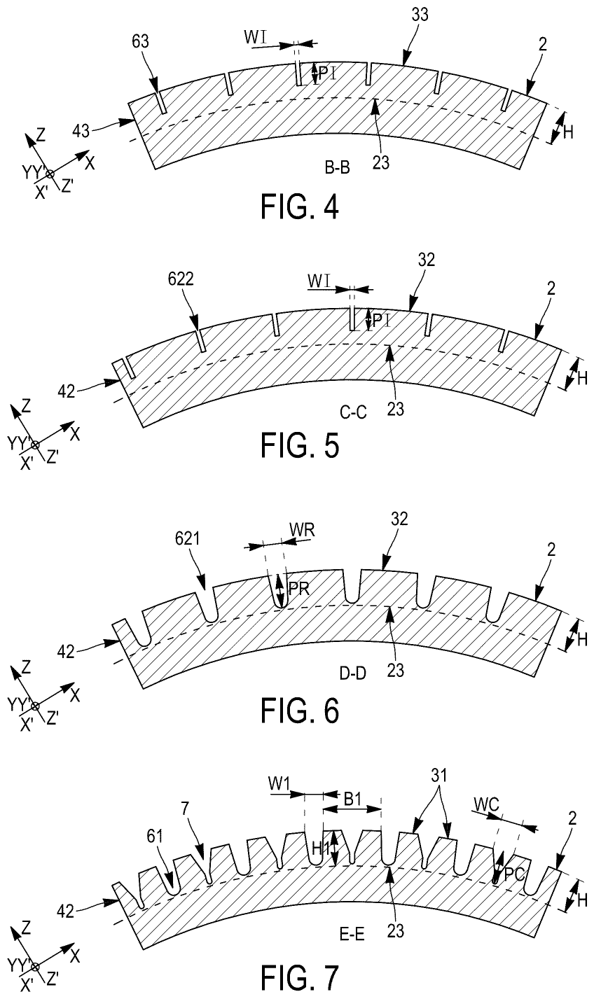

FIG. 4: Circumferential section through the median row of the tread according to the invention, through the median circumferential section plane B-B,

FIG. 5: Circumferential section through an intermediate row of the tread according to the invention, through a circumferential section plane C-C, in a second transverse sipe portion,

FIG. 6: Circumferential section through an intermediate row of the tread according to the invention, through a circumferential section plane D-D, in a first transverse groove portion,

FIG. 7: Circumferential section through a lateral row of the tread according to the invention, through a circumferential section plane E-E,

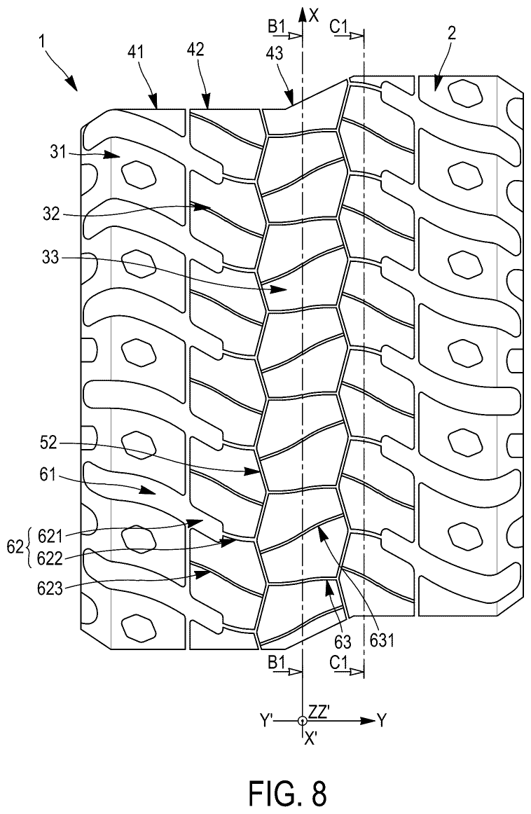

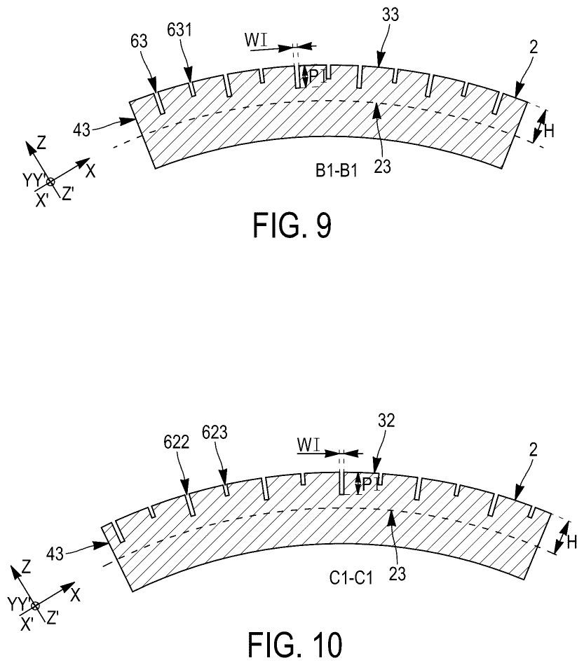

FIG. 8: Top view of a portion of a tread according to one variant of the invention, indicating the section planes of FIGS. 9 and 10,

FIG. 9: Circumferential section through the median row of the tread according to the variant of the invention in FIG. 8, through the median circumferential section plane B1-B1,

FIG. 10: Circumferential section through an intermediate row of the tread according to the variant of the invention in FIG. 8, through a circumferential section plane C1-C1, in a second transverse sipe portion.

In FIGS. 1 to 10, the various geometric dimensions are defined in a frame of reference XYZ defined by a longitudinal or circumferential direction XX′, which is tangential to the circumference of the tire along its running direction, a transverse or axial direction YY′, which is parallel to the axis of rotation of the tire, and a radial direction ZZ′, which is perpendicular to the axis of rotation of the tire. When the surface of the tread of the tire is a cylinder having a substantially rectilinear generatrix and the axis of rotation of the tire as axis of revolution, the radial direction ZZ′ is substantially perpendicular to the tread surface at any point on the tread surface.

FIG. 1 is a top view of a portion of a tread 1 according to the invention. The tread 1 of a tire for a heavy-duty vehicle that is intended to come into contact with the ground via a tread surface 2, comprises blocks (31, 32, 33) which are arranged in rows (41, 42, 43) along a longitudinal direction XX′ and are delimited by cuts (51, 52, 61, 62, 63). The tread 1 has a width L, measured along a transverse direction YY′ between two lateral edges 21 of the tread surface 2. The cuts (51, 52, 61, 62, 63) are at least partially either a wide cut, or groove, or a narrow cut, or sipe. The tread 1 comprises five rows (41, 42, 43) which are separated in pairs by a longitudinal cut (51, 52) and are distributed, along the transverse direction YY′, in a median row 43, centred on a median plane XZ perpendicular to the tread surface 2 at its middle, two intermediate rows 42, which are on either side of the median row 43 and are symmetrical in relation to the median plane XZ, and two lateral rows 41, which are transversely outermost and symmetrical in relation to the median plane XZ. The blocks (31, 32, 33) in one and the same row (41, 42, 43) are separated in pairs at least partially by a transverse cut (61, 62, 63). According to the invention, each transverse cut 61 in a lateral row 41 is a transverse groove extending from a lateral edge 21 of the tread surface 2 to an outer longitudinal cut 51. Also according to the invention, each transverse cut 62 in an intermediate row 42 comprises a first transverse groove portion 621, which continues a transverse groove 61 in the neighbouring lateral row 41 and extends from an outer longitudinal cut 51 to a transversely inner end E2 of the transverse groove portion 621, the latter being continued by a second transverse sipe portion 622 extending to an inner longitudinal cut 52. Also according to the invention, each transverse cut 63 in the median row 43 is a transverse sipe which extends from a first inner longitudinal cut 52 to a second inner longitudinal cut 52 and is offset, along the longitudinal direction XX′, in relation to every second transverse sipe portion 622 in the neighbouring intermediate row 42. Each outer longitudinal cut 51 has a mean line M1 positioned, in relation to the median plane XZ of the tread 1 and along the transverse direction YY′, at a mean distance D1 at least equal to 20% and at most equal to 35% of the width L of the tread 1. Each transversely inner end E2 of a transverse groove portion 621 in an intermediate row 42 is positioned, in relation to the median plane XZ of the tread 1 and along the transverse direction YY′, at a mean distance D2 at least equal to 10% and at most equal to 25% of the width L of the tread 1. The line M2 passes through all the transversely inner ends E2. Each inner longitudinal cut 52 has a mean line M3 positioned, in relation to the median plane XZ of the tread 1 and along the transverse direction YY′, at a mean distance D3 at least equal to 5% and at most equal to 20% of the width L of the tread 1. More specifically, the mean line around which the zigzag-shaped mean line of the inner longitudinal cut 52 oscillates is shown. Each longitudinal cut (51, 52) separating two adjacent rows (41, 42, 43) is a longitudinal sipe. Ventilation cavities 7, which open into the tread surface 2, are positioned along the longitudinal direction XX′ between two consecutive transverse grooves 61 in one and the same lateral row 41. Ventilation cavities 8, which open into a lateral face 22 of the tread but not into the tread surface 2 when the tire is new, are positioned along the longitudinal direction XX′ between two surfaces 611 into which consecutive transverse grooves 61 in one and the same lateral row 41 open.

FIG. 2 is a top view of a portion of a tread 1 according to the invention, indicating the section planes of FIGS. 3 to 7. The radial section plane, along the broken line A-A, defines a meridian section through the tread, in three radial section regions YZ respectively distributed between the lateral, intermediate and median rows. The circumferential section plane B-B defines a circumferential section through the median row. The circumferential section plane C-C defines a circumferential section through an intermediate row in a second transverse sipe portion. The circumferential section plane D-D defines a circumferential section through an intermediate row in a first transverse groove portion. The circumferential section plane E-E defines a circumferential section through a lateral row.

FIG. 3 is a meridian section through the tread according to the invention, along a broken section line A-A. The tread, which is intended to come into contact with the ground via a tread surface 2, comprises blocks which are arranged in rows (41, 42, 43) along a longitudinal direction XX′ and are delimited transversely by longitudinal cuts (51, 52). FIG. 3 shows a sectional view through the two lateral rows 41, the two intermediate rows 42 and the median row 43. Each intermediate row 42 is separated from the neighbouring lateral row 41 by an outer longitudinal cut 51 positioned at a mean distance D1 in relation to the median plane XZ, and from the median row 43 by an inner longitudinal cut 52 positioned at a mean distance D3 in relation to the median plane XZ. Each outer and inner longitudinal cut 51 and 52, respectively, is a sipe having a depth PI at least equal to 50% of the height H of the tread and a width WI strictly less than 20% of the said depth PI. The height H of the tread is equal to the maximum cut depth measured along a direction perpendicular to the tread surface 2: it is therefore the distance between the tread surface 2 and an imaginary surface 23 which is parallel to the tread surface 2 and tangential to the bottom of the cut having the maximum depth. The tread has a width L, measured along a transverse direction YY′ between two lateral edges 21 of the tread surface 2. A single lateral edge 21 is shown in FIG. 3, in the knowledge that the symmetrical part of the tread, in relation to the median plane XZ, is shown at the level of a meridian section through a transverse cut 61 of a lateral row 41. FIG. 3 also presents, in meridian section, a ventilation cavity 7 which opens into the tread surface 2 and has a depth PC at least equal to 70% of the height H—equal to 100% of the height H, in the case shown—, the said ventilation cavity 7 being positioned along the longitudinal direction XX′ between two consecutive transverse grooves (not shown in FIG. 3) in one and the same lateral row 41. Also shown is a ventilation cavity 8, which opens into a lateral face 22 of the tread but not into the tread surface 2 when the tire is new and is positioned along the longitudinal direction XX′ between two surfaces (not shown in FIG. 3) into which consecutive transverse grooves 61 in one and the same lateral row 41 open.

FIG. 4 is a circumferential section through the median row 43 of the tread according to the invention, through the median circumferential section plane B-B. The median row 43 comprises blocks 33 which are separated in pairs by transverse cuts 63. Each transverse cut 63 is a sipe having a depth PI at least equal to 50% of the height H of the tread and a width WI strictly less than 20% of the said depth PI. The height H of the tread is equal to the maximum cut depth measured along a direction perpendicular to the tread surface 2: it is therefore the distance between the tread surface 2 and an imaginary surface 23 which is parallel to the tread surface 2 and tangential to the bottom of the cut having the maximum depth.

FIG. 5 is a circumferential section through an intermediate row 42 of the tread according to the invention, through a circumferential section plane C-C, in a second transverse sipe portion 622. The blocks 32 in the intermediate row 42 are separated in pairs, in their transversely inner portion, by second transverse sipe portions 622. Each second transverse sipe portion 622 is a sipe having a depth PI at least equal to 50% of the height H of the tread, measured between the tread surface 2 and the imaginary surface 23 that is parallel to the tread surface 2 and tangential to the bottom of the cut having the maximum depth, and a width WI strictly less than 20% of the said depth PI.

FIG. 6 is a circumferential section through an intermediate row 42 of the tread according to the invention, through a circumferential section plane D-D, in a first transverse groove portion 621. The blocks 32 in the intermediate row 42 are separated in pairs, in their transversely outer portion, by first transverse groove portions 621. Each first transverse groove portion 621 is a groove having a depth PR at least equal to 50% of the height H of the tread, measured between the tread surface 2 and the imaginary surface 23 that is parallel to the tread surface 2 and tangential to the bottom of the cut having the maximum depth, and a width WR at least equal to 20% of the said depth PR.

FIG. 7 is a circumferential section through a lateral row 41 of the tread according to the invention, through a circumferential section plane E-E. The lateral row 41 comprises blocks 31 which are separated in pairs by transverse cuts 61. Each transverse cut 61 is a groove having a depth PR at least equal to 50% of the height H of the tread, measured between the tread surface 2 and the imaginary surface 23 that is parallel to the tread surface 2 and tangential to the bottom of the cut having the maximum depth, and a width WR at least equal to 20% of the said depth PR. Each block 31 in a lateral row 41, delimited by two consecutive transverse grooves 61, has a block height H1 along a direction perpendicular to the tread surface 2 and a block length B1 along the longitudinal direction XX′. Advantageously, the block height H1 is at most equal to 80% of the block length B1. Each transverse groove 61, delimited by two blocks 31, has a transverse groove width W1 along the longitudinal direction XX′. Advantageously, the transverse groove width W1 is at least equal to 18% and at most equal to 35% of the sum of the transverse groove width W1 and the block length B1. FIG. 7 also shows ventilation cavities 7 which open into the tread surface 2 and have a depth PC at least equal to 70% of the height H—equal to 100% of the height H, in the case shown—, the said ventilation cavities being positioned along the longitudinal direction XX′ between two consecutive transverse grooves 61 in one and the same lateral row 41.

FIG. 8 is a top view of a portion of a tread 1 according to one variant of the invention, indicating the section planes of FIGS. 9 and 10. FIG. 8 utilizes the same references as FIG. 1. The specific feature of this variant of the invention is the presence, in each intermediate row 42 and in the median row 43, of additional transverse through-sipes (623, 631), that is to say transverse sipes that respectively pass all the way through the blocks 32 in the intermediate rows 42 and the blocks 33 in the median region 43. All the transverse through-sipes 623 in an intermediate row 42 are positioned between two transverse cuts 62 in the intermediate row 42, at longitudinal distances from each of the said transverse cuts 62 that are substantially the same. All the transverse through-sipes 631 in the median row 43 are positioned between two transverse sipes 63 in the median row 43, at longitudinal distances from each of the said transverse cuts 63 that are substantially the same. FIG. 8 moreover presents a circumferential section plane B1-B1, defining a circumferential section through the median row 43, and a circumferential section plane C1-C1, defining a circumferential section through an intermediate row 42 in a second transverse sipe portion 622 of a transverse cut 62.

FIG. 9 is a circumferential section through the median row 43 of the tread according to the variant of the invention in FIG. 8, through the median circumferential section plane B1-B1. The median row 43 comprises blocks 33 that are separated in pairs by transverse cuts 63. Each transverse cut 63 is a sipe having a depth PI at least equal to 50% of the height H of the tread and a width WI strictly less than 20% of the said depth PI. The height H of the tread is measured along a direction perpendicular to the tread surface 2 between the tread surface 2 and an imaginary surface 23 which is parallel to the tread surface 2 and tangential to the bottom of the cut having the maximum depth. Moreover, each block 33 of the median row 43 comprises a transverse through-sipe 631 substantially equidistant from the two transverse sipes 63 that delimit the block 33 and have a depth less than the depth PI of the said transverse sipes.

FIG. 10 is a circumferential section through an intermediate row 42 of the tread according to the variant of the invention in FIG. 8, through a circumferential section plane C1-C1, in a second transverse sipe portion 622. The blocks 32 in the intermediate row 42 are separated in pairs, in their transversely inner portion, by second transverse sipe portions 622. Each second transverse sipe portion 622 is a sipe having a depth PI at least equal to 50% of the height H of the tread, measured between the tread surface 2 and the imaginary surface 23 that is parallel to the tread surface 2 and tangential to the bottom of the cut having the maximum depth, and a width WI strictly less than 20% of the said depth PI. Moreover, each block 32 of an intermediate row 42 comprises a transverse through-sipe 623 substantially equidistant from the two transverse cuts 62 that delimit the block 32 and have a depth less than the depth PI of the said transverse sipes.

The inventors more particularly studied this invention for a tire of size 59/80 R 63 that is intended to be mounted on a dumper and to carry a load equal to 100 000 kg when it is inflated to a pressure equal to 7 bar, in accordance with the TRA standard (TRA Year Book 2019).

The inventors compared, in the tire size 59/80 R 63, a tire I comprising a tread according to the invention with a reference tire R of size 59/80 R 63 of the Michelin XDR3 range.

Table 1 below shows the respective characteristics of a tread according to the invention and a reference tread:

TABLE 1

| Characteristics of the tread | Tire I | | Tire R | | Comments |
|---|---|---|---|---|---|
| Width L of the tread | 1208 | mm | 1233 | mm | |
| Height H of the tread | 100 | mm | 110 | mm | |
| (maximum depth of a cut) | | | | | |
| Depth PR of | 100 | mm | 110 | mm | |
| transverse/longitudinal | | | | | |
| groove | | | | | |
| Width WR of | 80 | mm | 55 | mm | |
| transverse/longitudinal | | | | | |
| groove | | | | | |
| Depth PI of | 80 | mm | NA (not | | |
| transverse/longitudinal sipe | | | applicable) | | |
| Width WI of | 15 | mm | NA | | |
| transverse/longitudinal | | | | | |
| groove | | | | | |
| Distance D1 of an outer | 342 | mm | 310 | mm | I: D1 = 28% L |
| longitudinal cut (in relation to | | | | | R: D1 = 25% L |
| the median plane XZ) | | | | | |
| Distance D2 of a transversely | 240 | mm | 290 | mm | I: D2 = 20% L |
| inner end of a transverse | | | | | R: D2 = 24% L |
| groove portion in an | | | | | |
| intermediate row (in relation | | | | | |
| to the median plane XZ) | | | | | |
| Distance D3 of an inner | 121 | mm | NA | | I: D3 = 10% L |
| longitudinal cut (in relation to | | | | | |
| the median plane XZ) | | | | | |
| Height H1 of a block 31 in | 100 | mm | 110 | mm | |
| lateral row 41 | | | | | |
| Length B1 of a block 31 in | 203 | mm | 194 | mm | I: H1/B1 = 49% |
| lateral row 41 | | | | | R: H1/B1 = 57% |
| Width W1 of a transverse | 80 | mm | 55 | mm | I: W1/(W1 + B1) = 28% |
| groove 61 between two | | | | | R: W1/(W1 + B1) = 22% |
| blocks 31 in lateral row 41 | | | | | |
| Width WC of a ventilation | 76 | mm | 51 | mm | |
| cavity 7 in lateral row 41 | | | | | |
| Depth PC of a ventilation | 100 | mm | 42 | mm | I: PC/H = 100% |
| cavity 7 in lateral row 41 | | | | | R: PC/H = 38% |

A tire I comprising a tread according to the invention and a reference tire R have been compared by tests carried out on construction plant vehicles, with respect to grip on wet ground and resistance to attacks caused by stones, and by digital simulations using the finite element method, to establish a map of the temperatures reached in the crown of the tire. As regards grip on wet ground, the braking distance for the tire according to the invention is approximately 9% less than that of the reference tire, mainly owing to the greater width and length of the lateral transverse cuts. As regards resistance to attacks caused by stones, at five different experimentation sites a significant reduction in chunking of material in the median part of the tread according to the invention compared with the reference tread was observed. As regards the temperature levels reached in the crown of the tire, digital simulations showed a potential reduction of 5° C. between the lateral rows of the respective treads of the tire according to the invention and the reference tire, and a potential reduction of 7° C. between the median portions of the respective treads of the tire according to the invention and the reference tire.

1. A tread of a tire for a heavy-duty vehicle that is intended to come into contact with the ground via a tread surface, comprising blocks which are arranged in rows along a longitudinal direction (XX′) and are delimited by cuts,
the tread having a width (L), measured along a transverse direction (YY′) between two lateral edges of the tread surface, and a height (H), which is equal to the maximum depth of a cut measured along a direction perpendicular to the tread surface,
the cuts being at least partially either a groove having a depth (PR) at least equal to 50% of the height (H) of the tread and a width (WR) at least equal to 20% of the said depth (PR), or a sipe having a depth (PI) at least equal to 50% of the height (H) of the tread and a width (WI) strictly less than 20% of the said depth (PI),
the tread comprising five rows which are separated in pairs by a longitudinal cut and are distributed, along the transverse direction (YY′), in a median row, centred on a median plane (XZ) perpendicular to the tread surface at its middle, two intermediate rows, which are on either side of the median row and are symmetrical in relation to the median plane (XZ), and two lateral rows, which are transversely outermost and symmetrical in relation to the median plane (XZ),
the blocks in one and the same row being separated in pairs at least partially by a transverse cut,
wherein each transverse cut in a lateral row is a transverse groove extending from a lateral edge of the tread surface to an outer longitudinal cut, in that each transverse cut in an intermediate row comprises a first transverse groove portion, which continues a transverse groove in the neighbouring lateral row and extends from an outer longitudinal cut to a transversely inner end (E2) of the transverse groove portion, the latter being continued by a second transverse sipe portion extending to an inner longitudinal cut (52), and wherein each transverse cut in the median row is a transverse sipe which extends from a first inner longitudinal cut to a second inner longitudinal cut and is offset, along the longitudinal direction (XX′), in relation to every second transverse sipe portion in the neighbouring intermediate row.

2. The tread according to claim 1, wherein each outer longitudinal cut has a mean line (M1) positioned, in relation to the median plane (XZ) of the tread and along the transverse direction (YY′), at a mean distance (D1) at least equal to 20% of the width (L) of the tread.

3. The tread according to claim 1, wherein each outer longitudinal cut has a mean line (M1) positioned, in relation to the median plane (XZ) of the tread and along the transverse direction (YY′), at a mean distance (D1) at most equal to 35% of the width (L) of the tread.

4. The tread according claim 1, wherein each transversely inner end (E2) of a transverse groove portion in an intermediate row is positioned, in relation to the median plane (XZ) of the tread and along the transverse direction (YY′), at a distance (D2) at least equal to 10% of the width (L) of the tread.

5. The tread according to claim 1, wherein each transversely inner end (E2) of a transverse groove portion in an intermediate row is positioned, in relation to the median plane (XZ) of the tread and along the transverse direction (YY′), at a distance (D2) at most equal to 25% of the width (L) of the tread.

6. The tread according to claim 1, wherein each inner longitudinal cut has a mean line (M3) positioned, in relation to the median plane (XZ) of the tread and along the transverse direction (YY′), at a mean distance (D3) at least equal to 5% of the width (L) of the tread.

7. The tread according to claim 1, wherein each inner longitudinal cut has a mean line (M3) positioned, in relation to the median plane (XZ) of the tread and along the transverse direction (YY′), at a mean distance (D3) at most equal to 20% of the width (L) of the tread.

8. The tread according to claim 1, wherein each longitudinal cut separating two adjacent rows is a longitudinal sipe.

9. The tread according to claim 1, wherein each inner longitudinal cut has a zigzag shape.

10. The tread according to claim 1, with each block in a lateral row, which blocks are delimited by two consecutive transverse grooves, having a block height (H1) along a direction perpendicular to the tread surface and a block length (B1) along the longitudinal direction (XX′), wherein the block height (H1) is at most equal to 80% of the block length (B1).

11. The tread according to claim 1, with each block in a lateral row having a block length (B1) along the longitudinal direction (XX′), and each transverse groove, delimited by two blocks, having a transverse groove width (W1) along the longitudinal direction (XX′), wherein the transverse groove width (W1) is at least equal to 18% of the sum of the transverse groove width (W1) and the said block length (B1).

12. The tread according to claim 1, with each block in a lateral row having a block length (B1) along the longitudinal direction (XX′), and each transverse groove, delimited by two blocks, having a transverse groove width (W1) along the longitudinal direction (XX′), wherein the transverse groove width (W1) is at most equal to 35% of the sum of the transverse groove width (W1) and the block length (B1).

13. The tread according to claim 1, wherein at least one ventilation cavity, opening into the tread surface and having a depth (PC) at least equal to 70% of the height (H), is positioned, along the longitudinal direction (XX′), between at least two consecutive transverse grooves in one and the same lateral row.

14. The tread according to claim 1, with the tread comprising two outer lateral faces, each intersecting the tread surface at a lateral edge of the tread surface, all transverse grooves in a lateral row opening into a lateral face of the tread along an open section, wherein at least one ventilation cavity, opening into a lateral face of the tread but not onto the tread surface when the tire is new, is positioned, along the longitudinal direction (XX′), between at least two surfaces into which consecutive transverse grooves in one and the same lateral row open.

15. A tire for a heavy-duty vehicle, that comprises a tread according to claim 1.
